(19) United States
(12) Patent Application Publication
(10) Pub. No.: US 2009/0172212 A1
(43) Pub. Date: Jul. 2, 2009

(54) System and method for managing input/output requests in data processing systems

(76) Inventor: Michael F. Stanton, Lino Lakes, MN (US)

Correspondence Address: Charles Johnson;Unisys Corporation, MS 4773, P.O. Box 64942, St. Paul, MN, 55164, US

(21) Appl. No.: 12/006,269

(22) Filed: Dec. 31, 2007

(51) Int. Cl. G06F 3/00

(52) U.S. Cl. 710/18

(57) ABSTRACT

An apparatus and method for managing input/output transactions in data processing systems. I/O processors (IOPs) of the computing system are logically separated into multiple groups. Multiple global completion indicator groups are provided, one for each of the groups of IOPs. A state of the global completion indicator group is modified by its respective group of IOPs when any of the IOPs of the respective group completes an I/O request. Each of the global completion indicator groups is independently monitored for I/O requests completed by any of the IOPs in the respective IOP group.

### FIELD OF THE INVENTION

The present invention relates in general to memory systems, and more particularly, to managing input/output transactions in data processing systems.

### BACKGROUND OF THE INVENTION

The efficient performance of input and output operations is an important aspect of computer system design. Contemporary large-scale computer systems typically interface with many different attached peripheral devices such as magnetic disk drives, optical disk drives, magnetic tape drives, cartridge tape libraries, and the like. A robust mechanism should thus be provided to send output to, and receive input from, such devices. The operating system software of the computer system, together with other software and microcode controlling the peripheral devices, should provide the application programmer with sufficient software interfaces so that the application program can implement its desired functionality. Input/Output (I/O) control systems are known in the art for providing common interfaces to the various peripheral devices attached to the computer system. One implementation of an I/O control system is known as an I/O Processor. An I/O processor (IOP) is a specialized processing unit in the computer system that is dedicated to performing I/O functions to and from the attached peripheral devices. The presence of the IOP improves overall system performance because it relieves the Central Processing Unit (CPU) or other Instruction Processors (IPs) from much of the processing overhead associated with I/O operations. In some large scale systems, there may be many IOPs, each connected to a subset of the entire system's set of peripheral devices. The IOP may, in conjunction with the operating system, support a secure, protected interface to the supported I/O functions for the benefit of the application programs being executed by the computer system. The IOP detects I/O request-related errors and ensures that the application program cannot corrupt the I/O resources of the computer system.

Processing I/O requests in large-scale computing systems can be particularly complex, as such systems often include multiple processing units (e.g. IPs), large shared memories and cache memories, and numerous peripheral devices connected at various locations. When IPs or other processing units request I/O services, they must be informed when the requested I/O operation(s) has completed. In large-scale computing systems described above, inefficiencies can occur in processing and handling such I/O transactions. It is desirable to reduce inefficiencies to reduce unnecessary processing, increase throughput, and/or facilitate debugging requirements. The present invention provides a manner for addressing the aforementioned and other shortcomings of the prior art.

### SUMMARY OF THE INVENTION

To overcome limitations in the prior art described above, and to overcome other limitations that will become apparent upon reading and understanding the present specification, the present invention discloses a system, apparatus and method for managing input/output transactions in data processing systems.

In accordance with one embodiment of the invention, a method is provided for managing input/output (I/O) requests in a computing system. The method includes grouping I/O processors (IOPs) of the computing system into multiple groups. Multiple global completion indicator groups are provided, one for each of the groups of IOPs. A state of the global completion indicator group is modified by its respective group of IOPs when any of the IOPs of the respective group completes an I/O request. Each of the global completion indicator groups is independently monitored for I/O requests completed by any of the IOPs in the respective IOP group.

A more particular embodiment further involves providing a control table for each IOP in the computing system, where each control table includes at least a local completion indicator and an identification of an addressable location of a status queue for the respective IOP, and where the local completion indicator provides the respective IOP with notification that the operating system is processing the completion of the I/O request.

According to another embodiment of such a method, modifying the state of the global completion indicator group involves writing at least one self-identifying characteristic of the IOP completing the I/O request to the global completion indicator group. In one embodiment the method further involves locating a control table unique to the IOP completing the I/O request using the at least one self-identifying characteristic.

Another embodiment of the method involves modifying the state of the global completion indicator group by writing a value unique to the IOP completing the I/O request to the global completion indicator group to notify an operating system of the identity of the IOP that completed the I/O request.

Yet another embodiment of such a method further involves locking the global completion indicator group until completion status processing is completed by an operating system operating on behalf of a first device. Another embodiment further involves directing the operating system of a second device to a predetermined counterpart global completion indicator group when it is determined that the global completion indicator group is locked.

Another embodiment involves processing the most recent entry on the global completion indicator group first. In yet another embodiment, modifying the state of the global completion indicator group involves modifying the state by the IOP that completed its I/O request. In still another embodiment, independently monitoring each of the global completion indicator groups for I/O requests completed involves independently monitoring each of the global completion indicator groups by one or more operating systems serving devices initiating the I/O requests.

In accordance with another embodiment of the invention, an apparatus for managing input/output (I/O) transactions is provided. The apparatus includes a plurality of input/output processors (IOPs), each associated with one of a plurality of groups. A memory is configured to store a state of a plurality of global completion indicators, one for each of the plurality of groups, the state of each of the global completion indicators indicating whether an IOP in the respective group has completed processing of an I/O request. An instruction processing system having an operating system is configured to monitor each of the global completion indicators in each of the groups for I/O requests completed by any of the IOPs in the respective IOP group.

One embodiment of such an apparatus further includes a plurality of cells, each including one or more instruction processors and a plurality of the IOPs, where each of the plurality of groups includes the IOPs of one of the plurality of cells.

According to one embodiment, the memory further includes a number of stored control tables, each control table including at least a local completion indicator and an identification of an addressable location of a status queue for the respective IOP. The local completion indicator provides the respective IOP with notification that the operating system is processing the completion of the I/O request.

In yet another embodiment, the memory is configured to store a unique identifier corresponding to the IOP that completed processing of the I/O request, where the unique identifier serves as the state which indicates that the IOP has completed processing of the I/O request.

In accordance with another embodiment of the invention, an apparatus is provided that includes devices for initiating I/O requests. Such devices may include, for example, instruction processors, or other circuitry associated with the computing system. Multiple IOPs are provided to process the I/O requests, each of the IOPs associated with one of a plurality of groups. Memory, cache or other storage is provided to store a number of global completion indicators, one for each of the groups of the IOPs. The IOP or other designated circuitry modifies a state of the global completion indicators by its respective group of IOPs when any of the IOPs of the respective group completes an I/O request. An instruction processor(s) and/or their respective operating system(s) independently monitor each of the global completion indicator groups for the I/O requests completed by any of the IOPs in the respective IOP group.

According to a more particular embodiment, the IOP or other circuitry that modifies the state of the global completion indicators is configured to modify the state by writing a unique identifier of the IOP that completed the I/O request. In another embodiment, the IP(s) and/or operating system(s) locates a control table and associated I/O completion status queue using the unique identifier of the IOP that completed the I/O request.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1 is block diagram illustrating an exemplary cluster processing system in which the present invention may be implemented;

FIG. 2 depicts a representative architecture of cluster lock server;

FIG. 3 illustrates another example of a computing system that involves I/O request processing;

FIG. 4 illustrates exemplary data structures to effect the I/O management in accordance with one embodiment of the invention;

FIG. 5 is a flow diagram illustrating one embodiment for managing I/O requests in accordance with the present invention; and

FIG. 6 illustrates an exemplary relationship between the global completion indicators and the local completion indicators.

### DETAILED DESCRIPTION OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

The present invention is generally related to input/output management. The present invention may be used in any type of computing system where input/output (I/O) functionality is implemented. For example, many, if not most computing systems employ peripheral devices to provide external elements to input information to the computing system, and to receive information from the computing system. Exemplary input devices include keyboards, mice, graphical input, voice input (e.g. microphones) and the like. Exemplary output devices include disk/tape drives and other storage elements, display units, printers, etc. The communication between the processing system and devices external to the computing system is generally referred to as input/output (I/O). I/O operations are thus performed to communicate information to or from these external or “peripheral” devices to carry out the ultimate I/O task.

In some computing systems such as large-scale computing systems, multiple instruction processors may be utilized to handle large processing demands. Similarly, such systems may require extensive I/O operations, and in some computing systems special processing devices are used to manage I/O operations. The use of such I/O processors, referred to herein as input/output processors (IOPs), relieve the primary instruction processors (IPs) from most, if not all, of the I/O processing requirements. While the present invention may be implemented in any computing system implementing I/O functions, the description provided herein is described in terms of computing systems employing multiple IOPs.

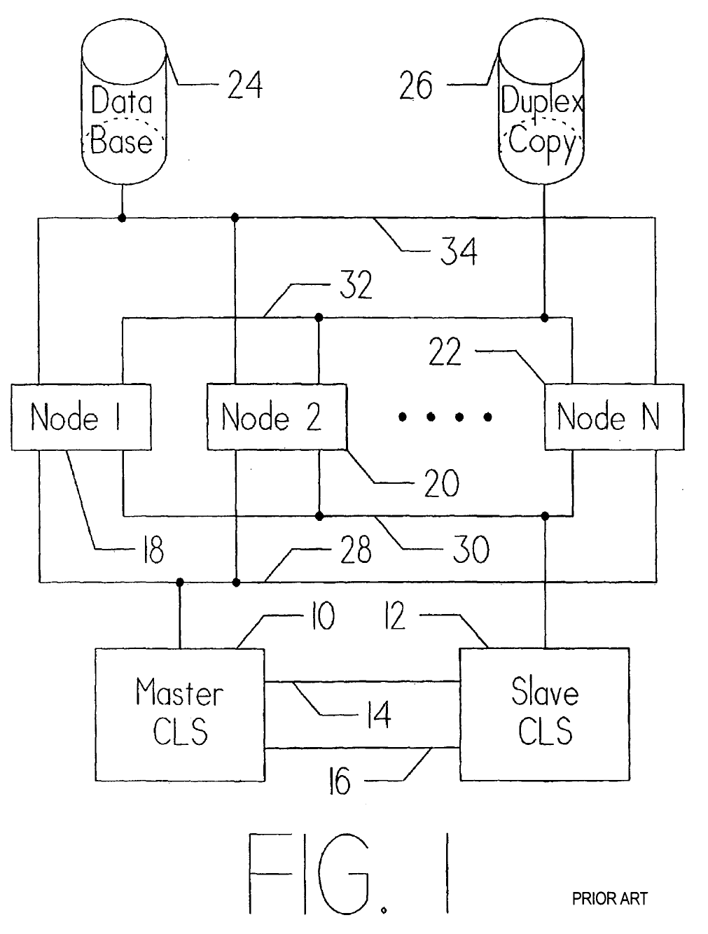

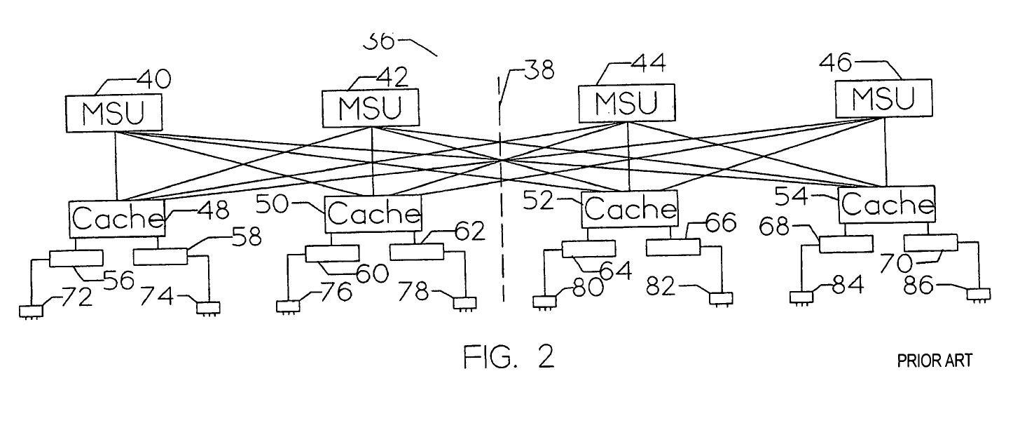

An exemplary computing system employing multiple IOPs, as well as multiple IPs, is described in FIGS. 1 and 2. These figures relate to a representative computing system further described in U.S. Pat. No. 7,000,046 which is incorporated herein by reference in its entirety. It should be recognized that the system described in FIGS. 1 and 2 is provided to facilitate an understanding of a representative computing system in which the present invention may be implemented. However, as will be readily apparent to those skilled in the art from the description provided herein, the invention is equally applicable to other computing systems performing I/O functions.

As is known in the art, computing systems may utilize multiple instruction processors (IPs). It can be difficult to create architectures that employ a relatively large number of such instruction processors. Representative difficulties include non-parallel problems which cannot be divided among multiple IPs; management problems which can slow throughput due to excessive contention for commonly used system resources; and system viability issues arising as a result of the large number of system components that can contribute to failures that may be propagated throughout the system. One solution to such problems is to utilize cluster processing, which utilizes a relatively large number of instruction processors that are “clustered” about various shared resources. Tasking and management tends to be decentralized with the cluster processors having shared responsibilities. For purposes of facilitating an understanding of one aspect of the invention, FIGS. 1 and 2 describe such a cluster processing system.

FIG. 1 illustrates a representative relationship of clustered hardware components. The commodity instruction processors node-1 18, node-2 20, and node-N 22 are preferably processor chips from industry compatible personal computers of the currently available technology. The total number of instruction processors is selected for the particular system application(s). Each of these instruction processors may communicate with, for example, database 24 and duplex copy 26 of database 24 via busses 34 and 32 respectively. This provides redundancy to recover from single point of failures within the database.

In addition to the interface with the database and its duplicate copy, the instruction processors can communicate with master CLS (Cluster Lock Server) 10 and slave CLS 12 via busses 28 and 30, respectively. Redundant connections to redundant cluster lock servers ensures that single point control structure failures can also be accommodated. Because the sole interface between the instruction processors (i.e., nodes 1, 2, . . . N) in the illustrated embodiment is with the master CLS and slave CLS, all services to be provided to an individual instruction processor are provided by the master CLS or slave CLS. The primary services provided include services to synchronize updates to one or more shared databases; services to facilitate inter-node communication; services to provide for shared data among the nodes; services to detect failing nodes in the cluster; and duplication of all information contained in the cluster lock server.

Where “locking” is employed, services provided for synchronization of database updates assume all nodes in the cluster use the same locking protocol. The CLS serves as the “keeper” of all locks for shared data. The locking functionality includes, for example, the ability for any node to request and release database locks; the ability to support multiple locking protocols; asynchronous notification to the appropriate node when a lock has been granted; automatic deadlock detection including the ability to asynchronously notify the nodes owning the locks that are deadlocked; and support for two-phase commit processing using XA including holding locks in the “ready” state across recoveries of individual nodes.

Inter-node communication services provide the capability for any node to send messages to and receive messages from any other node in the cluster. The ability for a node to broadcast to all other nodes is also provided.

Shared data services provide the capability for the nodes to share the common data structures required to facilitate the management and coordination of the shared processing environment. This data is maintained within the CLS.

Failed node detection services include heartbeat capability, the ability to move in-progress transactions from a failed node onto other nodes and the ability to isolate the failed node.

Although not required to practice the invention, in one mode, the CLS's are duplexed in a master/slave relationship. The nodes communicate with either the master or the slave with each ensuring all data is duplicated in the other. The ability of a node to communicate with either the master or the slave at any time increases resiliency and availability as the loss of the physical connection from the node to either the master or the slave does not affect the node's ability to continue operating. The master is responsible for control and heartbeat functions. In some cases the ability is provided to manually switch from the master to the slave. Manual switching facilitates testing and maintenance. Of course, automatic switching occurs upon failure of the master CLS.

FIG. 2 is a detailed block diagram 36 of a fully populated ES7000 Cellular Multi-Processor (CMP) system available from Unisys Corporation. In one embodiment, each of master CLS lo and slave CLS 12 consists of one of these computers. The ES7000 CMP is a commercially available product available from Unisys Corporation. One advantage of such a computing system is that it provides the cluster lock server with inherent scalability. It should be readily apparent that the total processing load on a cluster lock server increases directly with the number of cluster instruction processors which are directly managed by that cluster lock server. Thus, it is advantageous that a readily scalable processor is utilized for this purpose. It is further advantageous that the cluster lock server have the inherent reliability (e.g., failure recovery) and system viability (e.g., memory and shared resource protection) functionality to assume responsibility for these aspects of the systems operation.

In one implementation, a fully populated CMP contains up to four main memory storage units (MSUs), namely MSU 40, MSU 42, MSU 44 and MSU 46. These are interfaced as shown through up to four cache memory systems, cache 48, cache 50, cache 52 and cache 54. Each of the representative “subpods” 56, 58, 60, 62, 64, 66, 68, and 70 includes up to four instruction processors (IPs), each having its own dedicated cache memories. Duplexed input/output processors (IOPs) 72, 74, 76, 78, 80, 82, 84, and 86 interface with the cluster instruction processors shown in FIG. 1, with other cluster lock server(s), and with host computers. Thus, in the example of FIGS. 1 and 2, each of the cluster lock servers (i.e., master CLS 10 and slave CLS 12) includes an ES7000 CMP having from one to four MSU's, one to four caches, one to eight subpods, and one to eight duplexed input/output processors. This, however, is merely an example.

To further enhance reliability, and already a part of the ES7000 CMP system, various of the components are separately powered. In accordance with the fully populated system of block diagram 36, all components left of line 38 are powered by a first power source (not shown) and all components right of line 38 are powered by a second power source (not shown). In this manner, the system remains viable even during the course of a single power source failure.

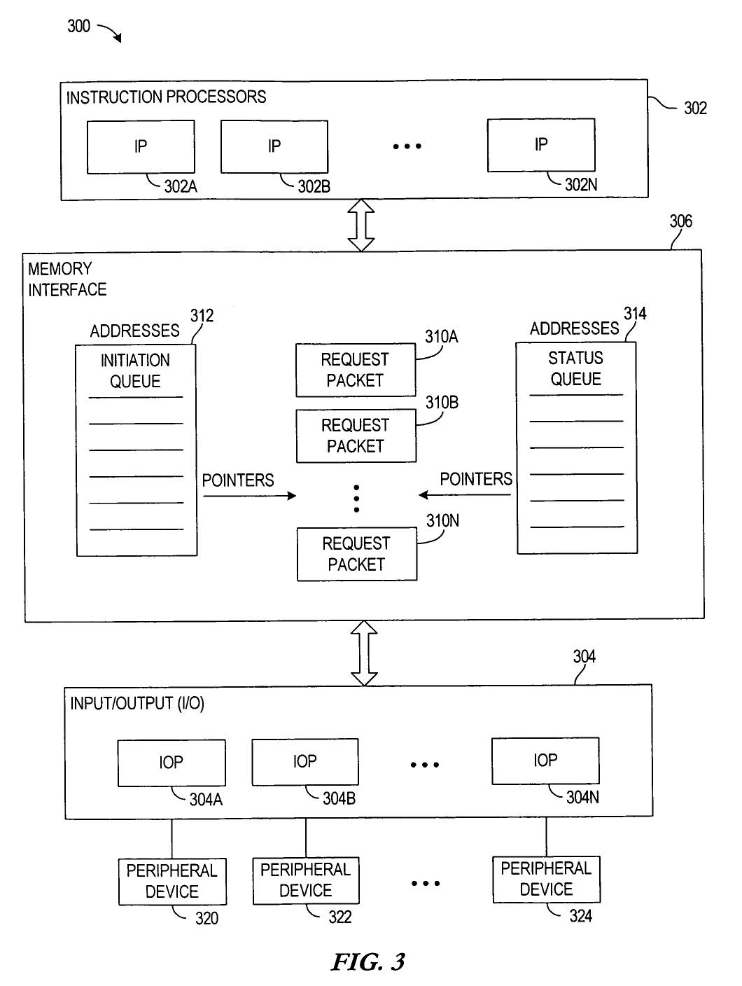

FIG. 3 illustrates another representative computing system 300 that depicts I/O request processing. The example of FIG. 3 includes a plurality of instruction processors 302, such as IP 302A, IP 302B, IP 302N. The computing arrangement 300 also includes an I/O portion 304 that includes a plurality of independently partitionable IOPs 304A, 304B, 304N coupled to a memory interface 306 that is also coupled to the IPs 302. Through the memory interface 306, the IOPs are able to process requests by accessing an appropriate request packet 310A, 310B, 310N. A request packet includes the appropriate information to carry out the desired I/O task, and thus a request packet may include, among other things, an I/O command. The request packets 310A, 310B, 310N are passed to the IOP through an initiation queue 312. More particularly, the initiation queue 312 entries each include a pointer to an active request packet 310A, 310B, 310N, thereby enabling the appropriate IOP to locate the particular request packet. The request packets may be stored contiguously or non-contiguously. In one embodiment, the initiation queue 312 is implemented as a fixed list of entries managed in a circular manner, such as a first-in-first-out (FIFO) queue. Entries in the initiation queue 312 include an address of its respective request packet 310A, 310B, 310N. The initiation queue 312 resides at an address that may be negotiated at any time, such as upon initialization of the IOPs 304A, 304B, 304N.

As the operations for each request are processed, the completion status is delivered to a respective request packet 310A, 310B, 310N. Each request packet may include a completion status field in addition to other fields (e.g. a command field, data descriptor field(s), etc.). Upon completion of I/O task and recording of the completion of that request in the respective request packet, an entry is also made in a status queue 314 by the IOP that completed the task. As with the initiation queue 312, the status queue 314 may be implemented as a FIFO queue or any other queuing arrangement. In one embodiment, each IOP has an associated status queue 314 (i.e. each status queue 314 is unique to an IOP), and the IOP stores the address of the next available location on the status queue to place an entry upon completion of an I/O task by that IOP. Entries in the status queue 314 include an address of its respective request packet in the request queue 310. The status queue 314 resides at an address that may be negotiated at any time, such as upon initialization of the IOPs 304A, 304B, 304N. An initiation queue 312 and status queue 314 is provided for each of the IOPs in the system 300.

In one embodiment notification to the I/O requesting device(s) of the presence of an entry on the status queue 314 is performed by notifying the IP's 302 operating system, also referred to herein as the operating system executive or simply “exec.” For example, when an application program needs to read data from or write data to one of the peripheral devices 320, 322, 324, the application program calls an exec I/O service to perform the requested action. Thus, an entry is made to the status queue 314 when the I/O task is completed by its respective IOP 304.

In operation, a requester passes the operating system (exec) a request to perform an I/O task. It should be recognized that used herein, the operating system or “exec” can refer to an operating system or exec for each of the IPs in the computing system, or may refer to a single instance of a virtualized operating system program. The operating system/exec translates the request from a relative memory address into an actual memory address. I/O commands are then passed to the IOP in the form of the request packets, such as via request packet 310A. The relevant IOP, e.g. IOP 304A, polls the initiation queue 312 or otherwise becomes aware of an entry on the initiation queue 312, and locates the request packet 310A from the pointer to that request packet 310A that is on the initiation queue 312.

In one embodiment, the IOP may poll for a valid flag on an initiation queue 312 entry to know when a request packet 310A, 310B, 310N has been issued for that entry. The IOP stores the address of the last initiation queue 312 entry from which an IOP task was initiated, so the IOP knows to monitor the valid flag of the next entry to determine when another I/O task is ready to be handled. When the valid flag is set, the IOP locates the request packet based on the pointer to that request packet. When the IOP completes processing the task (e.g. has transferred the appropriate data to/from buffers in memory), the IOP creates the status queue 314 entry that includes information corresponding to the information in the original entry on the initiation queue 312. The address of the request packet is thus passed back to the exec via information associated with the status queue 312 entry. As will be described in greater detail below, the IOP also facilitates notification to the exec of an available entry on the status queue via global completion indicators.

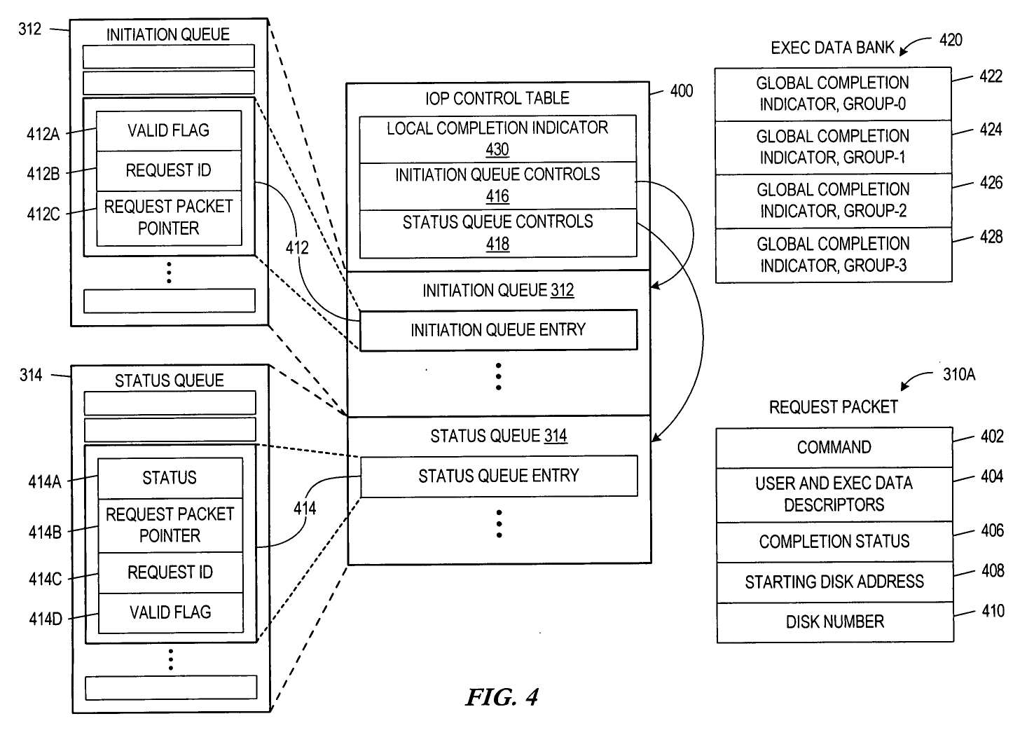

FIG. 4 illustrates exemplary data structures to effect the I/O management in accordance with one embodiment of the invention. FIG. 4 uses reference numbers corresponding to those in FIG. 3 where appropriate. An IOP control table 400 is provided for each IOP in the computing system. The IOP control table 400 includes various controls and indicators as described more fully below. In one embodiment, the initiation queue 312 and status queue 314 associated with an IOP are logically appended to the end of the corresponding IOP control table 400, but this is not required and the initiation queue 312 and status queue 314 can be stored anywhere in memory, cache, storage, etc. The IOP control table 400 will be described in greater detail below.

FIG. 4 also depicts a representative request packet, shown as request packet 310A. In one embodiment, a request packet includes at least a command 402 that specifies the action(s) or function(s) to be carried out by the IOP in connection with the I/O task or operation being requested. For example, the command could be a “write” command indicating that certain data is to be written to a disk or other peripheral storage device. User and/or exec data descriptors 404 may be provided in the request packet 310A to provide certain relevant information about the data that is the subject of the I/O operation. Other fields such as the starting disk address 408 and disk number 410 represent fields that assist in performing the I/O operation identified by the command 402. For example, in the case of an I/O write operation to disk, the disk number 410 identifies which disk of one or more disks the data is to be written, and the starting disk address 408 indicates where the data is to be written on that disk. It should be recognized that fields such as fields 408, 410 may change depending on the type of command 402 associated with the I/O request 310A.

The representative request packet 310A also includes a completion status field 406. As previously described, when an IOP completes a requested I/O operation, it notes completion of this I/O operation by modifying a completion status. In the illustrated embodiment, the completion status is modified in the same request packet 310A that initiated the I/O operation in the first place. When the IOP writes the appropriate information to the completion status field 406 to note completion of the I/O operation, an entry is made on the status queue 314 to notify the exec, operating system, or other similar I/O management utility that a requested I/O operation has been completed.

In FIG. 4 the initiation queue 312 and status queue 314 are shown as forming part of the IOP control table 400. A breakout view of each of the initiation queue 312 and status queue 314 are shown at the left side of the diagram. The initiation queue 312 is shown having a plurality of entries, one of which is entry 412 that is also depicted in the initiation queue 312 of the IOP control table 400. In the illustrated embodiment, each initiation queue 312 entry, such as entry 412, includes at least a valid flag 412A, request identifier (ID) 412B and request packet pointer 412C. As previously described, the IOP associated with this particular IOP control table 400 (and consequently the particular initiation queue 312 and status queue 314) polls, monitors, or otherwise obtains notification of a change in the valid flag 412A that indicates that an I/O operation is requested. The IOP knows to monitor a particular one or more valid flags 412A, as the IOP knows where the last initiation queue 312 entry was that an I/O entry was processed, and thus monitors the next one (or more) entries from that point. When the entries reach the end of the initiation queue 312, new entries are added at the beginning of the initiation queue 312 such that the initiation queue 312 operates as a circular queue in one embodiment. When noticing an asserted “valid flag” 412A, the IOP then knows to process that entry on the initiation queue 312. The request ID 412B represents the virtual address of the request packet 310A, ultimately enabling the exec to find the request packet 310A after the IOP completes the task and includes the request ID 414C in the status queue 314 entry 414. The request packet pointer 412C is the pointer to the request packet 310A that is used by the IOP to locate the appropriate request packet when the valid flag 412A indicates the existence of a new I/O task to be performed.

After processing the request, the IOP creates an entry 414 on the status queue 314. The status queue 314 entry 414 includes some information that is known from the original initiation queue 312 entry, such as the request packet pointer 414B and request ID 414C. The valid flag 414D in the status queue 314 can be used to indicate a new entry (e.g. entry 414) on the status queue 314. The status 414A is updated by the IOP to indicate the status of the requested I/O operation, such as indicating that the I/O operation is complete.

The IOP control table 400 depicts a data structure that the exec or other operating system uses to indicate where it is in processing the initiation queue 312 and status queue 314. Additionally, the IOP control table 400 includes other information such as the initiation queue controls 416 that point to the initiation queue 312, and the status queue controls 418 that point to the status queue 314.

In one embodiment, the IOP initiation 416 and status 418 queue controls include a table of indices managed by the operating system. They include what is essentially the beginning, ending and current addresses, and are used in managing the access to the items on the queue as a wrap around list. Initially a queue starts at the lowest address (Beginning) and entries are put on the list using a rolling current entry until it reaches the highest address minus one entry size. The next entry will be put in the Beginning address of the queue. The “Current” entry index in the queue controls is updated by the operating system according to the usage of the entries on the queue for the purpose of communicating between control threads executing on multiple IPs. In the case of an initiation queue 312, the operating system is putting new units of work relating to a data transfer or control function for a device in an area for the IOP to see that it is ready to be processed. The IOP maintains its own pointers to manage where it has processed the last pending unit of work. In the case of the status queue 314, the operating system is tracking the last notification from the IOP that a particular unit of work involving a data transfer or control function for a device has completed and been processed by the operating system. The IOP has its own independent set of indices for tracking where it put its last completion notification.

In accordance with one embodiment, the computing system architecture supports up to ninety-six IOPs, although the present invention is applicable to systems implementing any number of IOPs. There is one IOP control table 400 for each of the possible IOPs in the system. As is described more fully below, each IOP is assigned a unique Universal Processor Interface (UPI) value, and that UPI value is associated with a different IOP control table 400. While any unique value could be used to identify an IOP, the UPI value is an architectural number that defines where the IOP is connected to, and thus each UPI can be used to uniquely identify a respective IOP, which can then be used to look up the respective IOP control table 400 for that IOP.

In accordance with the present invention, once an entry is written to the status queue 314, the particular IOP that is associated with that IOP control table 400 and status queue 314 notifies the exec that an I/O request within any IOP has been completed. This is accomplished by writing to one of a plurality of global completion indicators, and also to a local completion indicator associated with that IOP. The global completion indicators 422, 424, 426, 428 are shown in FIG. 4 as part of the exec data bank 420, and the local completion indicator 430 for that IOP is shown as part of the IOP control table 400. The use of the global and local completion indicators are now described in greater detail.

When an IOP completes processing an I/O request, it updates the completion status 406 of the request packet 310A, places an entry 414 on the status queue 314, and writes to one of the global completion indicators and writes to the local completion indicator associated with its IOP control table 400. Writing to a global completion indicator 422-428 indicates that something has been written to a status queue 314, and indicates that the exec should check the local completion indicator 430 for that IOP to find what has changed.

In accordance with one embodiment of the invention, each global completion indicator 422-428 represents groups of IOPs. Thus, in one embodiment, an indication that IOP processing by one or more of the IOPs within a group of IOPs has completed an I/O task. For example, in one embodiment the global completion indicator of the IOPs is split into groups arranged by cell number—i.e. by cell (i.e. subset) of the computing structure that the IOP belong to. In this manner, the references to the IOP data structures are kept local to a given IP cell. In one representative embodiment each cell pair (IP and IOP) can have an IOP group, and the IOPs are grouped together in groups of sixty-four. Thus, there is one global completion indicator for each IOP group. While the division into groups can be made in any desired manner, one embodiment involves dividing the groups of IOPs based on cell number as the IPs and IOPs sharing a cell share the same memory interface (e.g. third level cache interface). Among other advantages, using multiple global completion indicators and dividing the IOPs into groups minimizes contention on memory.

Operation of the global completion indicators and local completion indicators involves the use of the UPI value in one embodiment of the invention. Rather than using a simple indicator (e.g. 0 or 1 flag) as the global completion indicator or local completion indicator, one embodiment of the invention writes the UPI number to the global completion indicator and the local completion indicator. Consequently, writing to the global completion indicator or local completion indicator uses a self-identifying indicator. It identifies the IOP that actually completed the I/O to the exec, and the system then knows which IOP recently completed the work. Because each global completion indicator 422-428 is associated with a group of IOPs, and each IOP is uniquely associated with a different UPI number, then each global completion indicator 422-428 is associated with multiple UPI numbers. When the exec notices a UPI indicator on any of the global completion indicators 422-428, the exec can determine which IOP initiated it, and the exec then refers to the IOP control table 400 corresponding to the UPI of that IOP. The exec then looks at the completion status 406 in the request packet 310A of the I/O operation from the corresponding entry 414 in the status queue 314.

By using the UPI number in the appropriate global completion indicator 422-428, no further lookup is required by the exec to determine which IOP completed the I/O task. While four global completion indicator groups 422, 424, 426, 428 are depicted, any number of groups can be implemented. In addition, one embodiment involves locking access to the global completion indicator group 422-428 when an indication from that group is present and recognized by the exec. The global completion indicator (e.g. the UPI number) is then used as an index to find the appropriate IOP control table 400, and the global completion indicator group is then locked. For example, the index table can include one pointer per UPI number, and that pointer is used to locate the IOP control table 400 that corresponds to the IOP that last wrote to the global completion indicator. The local completion indicator 430 in that IOP control table 400 also identifies the IOP that completed the I/O task, where the status of the completed I/O operation can be determined.

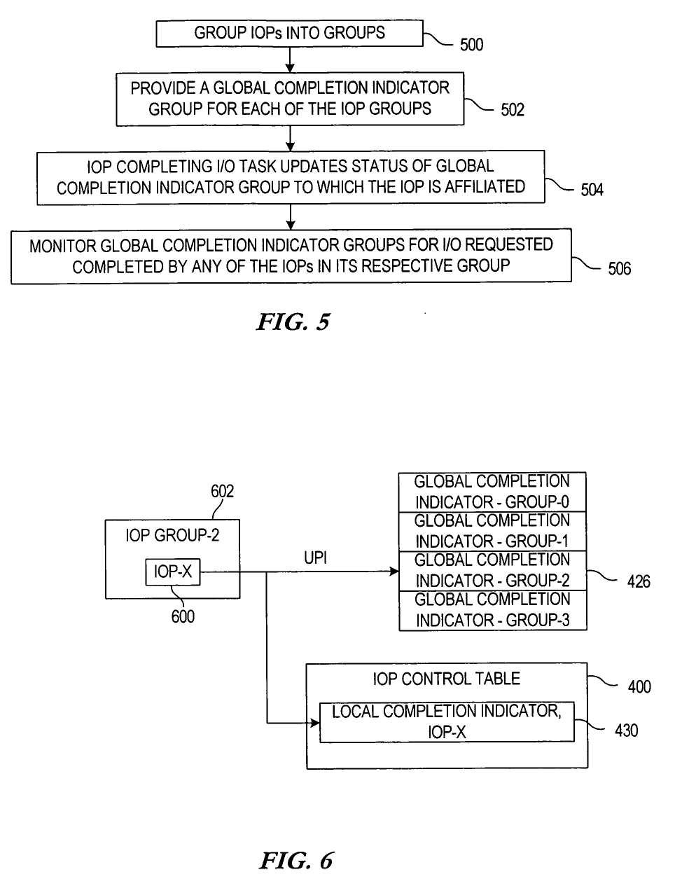

FIG. 5 is a flow diagram illustrating one embodiment for managing I/O requests in accordance with the present invention. In the illustrated embodiment, the IOPs are grouped 500, such as by IP cell. A global completion indicator group is provided 502 for each of the IOP groups. The IOP completing the I/O task updates 504 the status of the global completion indicator group to which the IOP is affiliated. As previously described, one embodiment for updating the status is to write the UPI number of the IOP that completed the requested I/O operation to the global completion indicator group. The exec monitors 506 the completion global indicator groups for requested I/O that is completed by any IOPs in its respective group.

FIG. 6 illustrates an exemplary relationship between the global completion indicators and the local completion indicators. For purposes of example, it is assumed that an IOP, shown as IOP-X 600, is part of an IOP group-2 602 of a plurality of IOP groups. FIG. 6 uses reference numbers corresponding to those in FIG. 4 where appropriate.

A given global completion indicator 604 is shared by other IOPs in a given group 602, and contains the identity of the IOP that last wrote that global completion indicator. However, the other IOPs in that group 602 may write to the global completion indicator 426 for that group at any time. To ensure that the completion of operations by all IOPs in a group 602 are detected in a timely fashion, a local completion indicator 430 that contains status localized to a single IOP is also used via a secondary mechanism of scanning local completion indicators belonging to all members of an IOP group for completions after processing the most recent completion as represented by the detected contents of the global completion indicator. The local completion indicator, shown as local completion indicator IOP-X 430, is associated with its IOP control table 400, thus allows the IOP-X 600 to determine whether the exec is servicing requests. The local completion indicator 430 tells the exec that this particular IOP-X 600 (associated with the IOP control table 400 that includes the local completion indicator 430) actually does have something that has not yet been processed by the exec—e.g., pending processing for the exec. The local completion indicator 430 also enables the IOP-X 600 to know whether the exec has actually picked up the entry and processed it—i.e. it informs the IOP-X 600 that the exec is looking at that IOP-X 600. Thus in one embodiment, a control table is provided for each input/output processor in the computing system, where each control table includes at least a local completion indicator and an identification of an addressable location of a status queue for the respective input/output processor, and where the local completion indicator provides the respective input/output processor with notification that the operating system is processing the completion of the input/output request.

The present invention also provides additional features to enhance the management of I/O transactions. As described above, one embodiment of the invention involves providing a plurality of global completion indicators, one for each of a plurality of “groups” of IOPs. In one embodiment, these groups are based on cell number, as IOPs and IPs may be grouped into cells, such as “IP cells” “IP/IOP cell pairs. For example, an IP/IOP cell pair can include one or more IPs and a plurality of IOPs that share a common port to memory in some architecturally dependent manner. The references to the IOP data structures can be kept local to a given cell. This arrangement of the global completion indicators in groups on shared cache boundaries (e.g. shared 3^{rd} level cache boundaries) of sixteen words can, for example, minimize cross global completion indicator “operand miss wait states.” In one embodiment, the global completion indicator is moved to a data structure with the group controls, and introducing a “taken” indicator to avoid repeated collisions on busy conditions. The data structure with the group controls can be implemented using, for example, a high level programming language representation of a data structure definition. The “taken” flag allows the status distributor to roll over to an alternative UPI number in the same group when an IOP is found to be undergoing status processing on another IP.

Thus, the taken flag serves as a locking mechanism to lock the structure. When a global completion indicator is processed an IP operating system (exec), the global completion indicator group is locked to keep others from accessing it, which controls contention on the status tabling. Rather than others who are requesting the lock continually retrying the lock until it can be obtained, the device requesting the lock (e.g. another IP) is directed to a predetermined counterpart global completion indicator group and processes that. Thus, the invention allows for locking of the global completion indicator group until completion status processing is completed by the operating system/exec that is operating on behalf of the requesting device(s), and also for directing the operating system of another requester (which could be the same or different operating system) to a predetermined counterpart global completion indicator group when it is determined that the global completion indicator group is locked.

This feature, referred to herein as the Lock Busy Rollover function, allows useful work to be performed in a “buddy set” of data structures without the high cost incurred from waiting for availability of structures that may be locked for an indeterminate amount of time ranging from nanoseconds to multiple milliseconds. This also reduces the likelihood of contention inherent to collisions between the holder of the lock and the requestor of the lock from memory latency wait states due to required cache memory residency and data ownership grants.

Another embodiment involves first processing requests from an IOP of a group that appears to be most frequently writing to the global completion indicator for that group. Because one embodiment of the invention involves writing the UPI or other unique IOP identifier to the global completion indicator for the IOP's group, it can be assumed that the IOP that is most frequently writing to the global completion indicator is the IOP that is completing the most work. This can be determined by the UPI in the global completion indicator. For example, if there are I/O functions with four IOPs, and there is three times as much I/O involved with IOP-o in the group relative to the other IOPs, IOP-o will be writing most frequently to the global completion indicator. Thus, IOP-o will be seen most often in that global completion indicator, and because that IOP-o is seen most often, it can be processed first. One manner of accomplishing this is to process the last IOP who wrote to the global completion indicator. The premise is that the last IOP to write the global completion indicator is the IOP that most recently completed the work. The IOP who is most frequently completing work is going to write to the global completion indicator more often, and thus will be found at the global completion indicator most often. Thus, the invention also enables processing the most recent entry on the global completion indicator group first.

Among other things, the present invention thus enables the use of self-identifying characteristics (such as a UPI number or other unique IOP identifier) of the IOP to rapidly locate data structures for processing the most recently completed operations in an environment with multiple serving peer devices. The invention also provides for the rapid selection of alternative work when the preferred unit of work has processing pending within the framework of other concurrent execution threads. Collisions due to data sharing can be reduced by distributing the processing of units of work characterized by their locality and ownership in the configuration. Data references can be affinitized in a way that uniquely uses their ownership and locality in the overall system configuration to minimize the impact of reference wait states due to memory locality and connection attributes. Sharing of the data structures used in selection and management of events can be managed in a way that provides for resilience in cases of component failure or dynamic repartitioning of the computing system hosting the operating system. Placement of data structures can be effected in a manner that minimizes the impact to unrelated or indirectly related adjacent data structures such that they can be efficiently shared between localities. As used herein, “locality” or “localities” refers to, for example, the residence point of data structures in memory, accessed through one or more potentially multi-ported memory controller(s), as seen by an IP through references via a multiplicity of layered memory caches each potentially having segments of multiplicity of segment sizes.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method for managing input/output requests in a computing system, comprising:
grouping input/output processors of the computing system into a plurality of groups;
providing a plurality of global completion indicator groups, one for each of the groups of input/output processors;
modifying a status of the global completion indicator group by its respective group of input/output processors when any of the input/output processors of the respective group completes an input/output request; and
independently monitoring each of the global completion indicator groups for input/output requests completed by any of the input/output processors in the respective input/output processor group.

2. The method of claim 1, further comprising providing a control table for each input/output processor in the computing system, each control table comprising at least a local completion indicator and an identification of an addressable location of a status queue for the respective input/output processor, wherein the local completion indicator provides the respective input/output processor with notification that the operating system is processing the completion of the input/output request.

3. The method of claim 1, wherein modifying a state of the global completion indicator group comprises writing at least one self-identifying characteristic of the input/output processor completing the input/output request to the global completion indicator group.

4. The method of claim 3, further comprising locating a control table unique to the input/output processor completing the input/output request using the at least one self-identifying characteristic.

5. The method of claim 1, wherein modifying a state of the global completion indicator group comprises writing a value unique to the input/output processor completing the input/output request to the global completion indicator group to notify an operating system of the identity of the input/output processor that completed the input/output request.

6. The method of claim 1, further comprising locking the global completion indicator group until completion status processing is completed by an operating system operating on behalf of a first device.

7. The method of claim 6, further comprising directing the operating system of a second device to a predetermined counterpart global completion indicator group when it is determined that the global completion indicator group is locked.

8. The method of claim 1, further comprising processing the most recent entry on the global completion indicator group first.

9. The method of claim 1, wherein modifying a state of the global completion indicator group comprises modifying the state by the input/output processor that completed its input/output request.

10. The method of claim 1, wherein independently monitoring each of the global completion indicator groups for input/output requests completed comprises independently monitoring each of the global completion indicator groups by one or more operating systems serving devices initiating the input/output requests.

11. An apparatus for managing input/output transactions, comprising:
a plurality of input/output processors, each associated with one of a plurality of groups;
a memory configured to store a state of a plurality of global completion indicators, one for each of the plurality of groups, the state of each of the global completion indicators indicating whether an input/output processor in the respective group has completed processing of an input/output request; and
an instruction processing system having an operating system configured to monitor each of the global completion indicators in each of the groups for input/output requests completed by any of the input/output processors in the respective input/output processor group.

12. The apparatus as in claim 11, further comprising a plurality of cells, each comprising one or more instruction processors and a plurality of the input/output processors, and wherein each of the plurality of groups comprises the input/output processors of one of the plurality of cells.

13. The apparatus as in claim 11, wherein the memory further comprises a plurality of stored control tables, each control table comprising at least a local completion indicator and an identification of an addressable location of a status queue for the respective input/output processor, wherein the local completion indicator provides the respective input/output processor with notification that the operating system is processing the completion of the input/output request.

14. The apparatus as in claim 11, wherein the memory is configured to store a unique identifier corresponding to the input/output processor that completed processing of the input/output request, wherein the unique identifier serves as the state which indicates that the input/output processor has completed processing of the input/output request.

15. An apparatus for managing input/output (I/O) transactions, comprising:
means for initiating input/output requests;
a plurality of input/output processors to process the input/output requests, each of the input/output processors associated with one of a plurality of groups;
means for storing a plurality of global completion indicators, one for each of a plurality of groups of the input/output processors;
means for modifying a state of the global completion indicators by its respective group of input/output processors when any of the input/output processors of the respective group completes an input/output request; and
means for independently monitoring each of the global completion indicator groups for the input/output requests completed by any of the input/output processors in the respective input/output processor group.

16. The apparatus as in claim 15, wherein the means for modifying the state of the global completion indicators comprises means for modifying the state by writing a unique identifier of the input/output processor that completed the input/output request.

17. The apparatus as in claim 16, further comprising means for locating a control table and associated input/output completion status queue using the unique identifier of the input/output processor that completed the input/output request.
